(19) United States
(12) Patent Application Publication
(10) Pub. No.: US 2006/0122718 A1
(43) Pub. Date: Jun. 8, 2006

(54) Data processing device, control method of data processing device, control program and manufacturing method of data processing device

(75) Inventors: Yoko Fujii, Kawasaki (JP); Ken Hayashida, Kawasaki (JP); Munehisa Kamio, Kawasaki (JP); Junichi Wagatsuma, Sapporo (JP); Norikazu Oshina, Sapporo (JP); Naoto Yamashita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/133,384

(22) Filed: May 20, 2005

(30) Foreign Application Priority Data
Dec. 8, 2004 (JP) 2004-354854

(51) Int. Cl. G06F 19/00

(52) U.S. Cl. 700/97; 700/83

(57) ABSTRACT

A data processing device provided with a user interface comprises a setting data storage unit for storing design setting data in order to realize a plurality of operational environment designs corresponding to each different appearance design of the data processing device, an identification data acquisition unit for obtaining identification data uniquely set for each appearance design of the data processing device and a control unit for reading design setting data corresponding to the appearance design of the data processing device, specified by the identification data and setting an operational environment design in the data setting device.

### BACKGROUND OF THE INVENTION

1. Field of the Invention

The present invention relates to a data processing device, the control method of the data processing device, a control program and a manufacturing method of the data processing, and more particularly to an effective technology for applying an operational environment design, such as an image, an icon, illumination color, music, etc., to a data processing device, such as a portable data terminal capable of being customized by a user.

2. Description of the Related Art

For example, in a data processing device, such as a portable terminal represented by a cellular phone, etc., not only its function but also the appearance design of hardware (a cabinet) and the like are diversified according to the age, interest and taste of users. Therefore, it has become more and more important in the development of a data processing device, such as a portable terminal, etc., to properly set an operational environment design, such as an image, an icon, illumination color, music, etc.

However, conventionally, the design of operational environment, such as an image, an icon, illumination color, music, etc., is a fixed default value, regardless of a variety of cabinet design taste.

Therefore, in a conventional portable terminal, even if an operational environment design matched with a variety of cabinet designs is provided, it becomes a uniform fixed default value when power switched on for the first time immediately after its procurement. Therefore, in order to realize an operational environment design matched with the cabinet design taste, a user has to do troublesome work of individually modifying each setting item.

Moreover, the operational environment design returned to a fixed uniform default value of the above-mentioned, regardless of the design of the case (coloring etc.) when returning it to the setting immediately after its procurement by the user operation, after the user had individually changed the setting of the operation environment designs of the image, the icon, the lighting color, and music, etc. Therefore, it was necessary to do a complex same set operation again to restore former setting.

As described above, a conventional portable terminal lacks in serviceability from the viewpoint of realizing the appropriate operational environment design of a user interface, matched with cabinet design taste, which is a technical problem.

In order to solve such a technical problem, a user has to prepare software for realizing an individual operational environment design corresponding to the appearance design of a cabinet (hardware) in order to realize operational environment design matched with a cabinet design when starting using a portable terminal for the first time. However, it is difficult to realize it since a new problem, such as the increase of development man-hours, the troublesome software management, etc., occurs.

Even if a variety of operational environment design data matched with cabinet design taste is provided with much trouble, a user does not notice it, and such a product advantage of the portable terminal cannot be appealed to a user.

Patent Reference 1 discloses a technology for setting a variety of functions, such as key touch-tone, communication speed, etc., without providing a special hardware switch, by executing a default setting routine when switching a telephone terminal set on, and detecting the pushing of a special dial button by a user while executing the default setting routine.

However, it also requires user's intervention as in the case of the above-mentioned prior art, and it cannot also solve the above-mentioned technical problem.

Patent Reference 2 also discloses a technology for matching the respective execution states of peripheral hardware and software with each other regardless of its model, by making waiting process time variable according to the type of hardware when starting a game machine. However, it does not disclose its function modification according to the cabinet design of the equipment.

Patent Reference 3 also discloses a technology for transmitting application software after determining the model of a cellular phone on the server side and automatically converting menu button images into ones suitable for the indication form of the model when the application software is downloaded from the server to the cellular phone. However, the modification of menu images according to the indication form of each model is based on hardware constraints and the difference of cabinet design taste or the like is not recognized.

Patent Reference 1:

Japanese Patent Application No. S60-124150

Patent Reference 2:

Japanese Patent Application No. 2003-135695

Patent Reference 3:

Japanese Patent Application No. 2003-76637

### SUMMARY OF THE INVENTION

It is an object of the present invention to realize an appropriate operational environment design matched with the cabinet design taste of a data processing device without bothering a user.

It is another object of the present invention to provide a data processing device with an appropriate operational environment design matched with the cabinet design taste without the increase of development man-hours, troublesome software management and the like.

It is another object of the present invention to provide a data processing device capable of realizing an appropriate operational environment design corresponding to the change of a cabinet design after shipment without a troublesome setting operation.

The first aspect of the present invention provides a data processing device, which comprises a setting data storage unit for storing design setting data to realize a plurality of operational environment designs corresponding to each different appearance design of the data processing device, an identification data acquisition unit for obtaining identification data uniquely set for each of the appearance designs of the data processing device, and a control unit for reading the design setting data from the setting data storage unit by the identification data and setting the operational environment design in the data processing device.

The second aspect of the present invention provides a control method, which comprises a first step of setting design software in the data processing device to realize a plurality of operational environment designs corresponding to each different appearance design of a data processing device, a second step of identifying the appearance design of the data processing device, based on hardware design identification data, and a third step of setting the operational environment design in the data processing device, using the design software corresponding to the identification result of the second step.

The third aspect of the present invention provides a signal for carrying a control program for enabling the data processing device to execute a process. Said process comprises a first step of identifying the appearance design of the data processing device, based on hardware design identification data, a second step of selecting the design software corresponding to the identification result of the first step from a plurality of segments of design software to realize a plurality of operational environment designs corresponding to each different appearance design of the data processing device, and a third step of setting the operational environment design in the data processing device, using the selected design software.

The fourth aspect of the present invention provides a manufacturing method, which comprises a step of preparing a plurality of segments of design setting data for realizing a plurality of operational environment designs corresponding to each different appearance design of a data processing device and a control program for enabling the data processing device to realize a first function to identify the appearance design of the data processing device and a second function to set the operational environment design in the data processing device, using the design setting data corresponding to the identification result of the first function, and a step of installing the plurality of segments of design setting data and the control program in the data processing device.

In the above-mentioned present invention, for example, if there are data processing devices, such as portable terminals, whose appearance are different and are cabinet designs A, B and C, the control program recognizes identification data attached in order to distinguish the cabinet designs from each other, and operational environment designs, such an image, an icon, illumination color music, voice, vibration, etc., coordinated for the cabinet designs A, B and C are automatically set in each data processing device as individual default values.

Therefore, an operational environment design matched with cabinet design taste can be set easily, rapidly and appropriately without a user's troublesome setting operation. Even if the state of the operational environment design of a data processing device is restored to the default setting at the time of purchase by a user operation, the operational environment design can also be restored to another appropriate cabinet design default value of the data processing device. In this case, no troublesome operation is needed to restore the operational environment design to one matched with a cabinet design taste.

According to the present invention, total design coordination between the cabinet design of a data processing device, provided by a manufacturer and the operational environment design of a user interface can also be set at its manufacturing stage. In this case, since a data processing device can be appealed to a user at the stage of its first use immediately after shipment, the product value of the data processing device in the market is improved.

Even if the cabinet design of a data processing device is modified, for example, by so-called “dress-up” or the like after shipment, an appropriate operational environment design can be easily set by preparing design setting data matched with the cabinet design after dress-up.

### BRIEF DESCRIPTION OF THE DRAWINGS

FIG. 1 is a flowchart showing an example of the manufacturing process of the data processing device in the first aspect of the present invention.

FIG. 2 is a flowchart showing an example of the operation of the data processing device in the first aspect of the present invention.

FIG. 3 shows the basic flowchart showing an example of the operation of the data processing device in the first aspect of the present invention.

FIG. 4 is a block diagram showing an example of the configuration of the data processing device in the first aspect of the present invention.

FIG. 5 shows data possessed by the data processing device in the first aspect of the present invention.

FIG. 6 is a perspective illustration showing an example of the appearance of the data processing device in the first aspect of the present invention.

FIG. 7 is a perspective illustration showing a variation of the data processing device in the first aspect of the present invention.

### DESCRIPTION OF THE PREFERRED EMBODIMENTS

The preferred embodiments of the present invention are described in detail below with reference to the drawings.

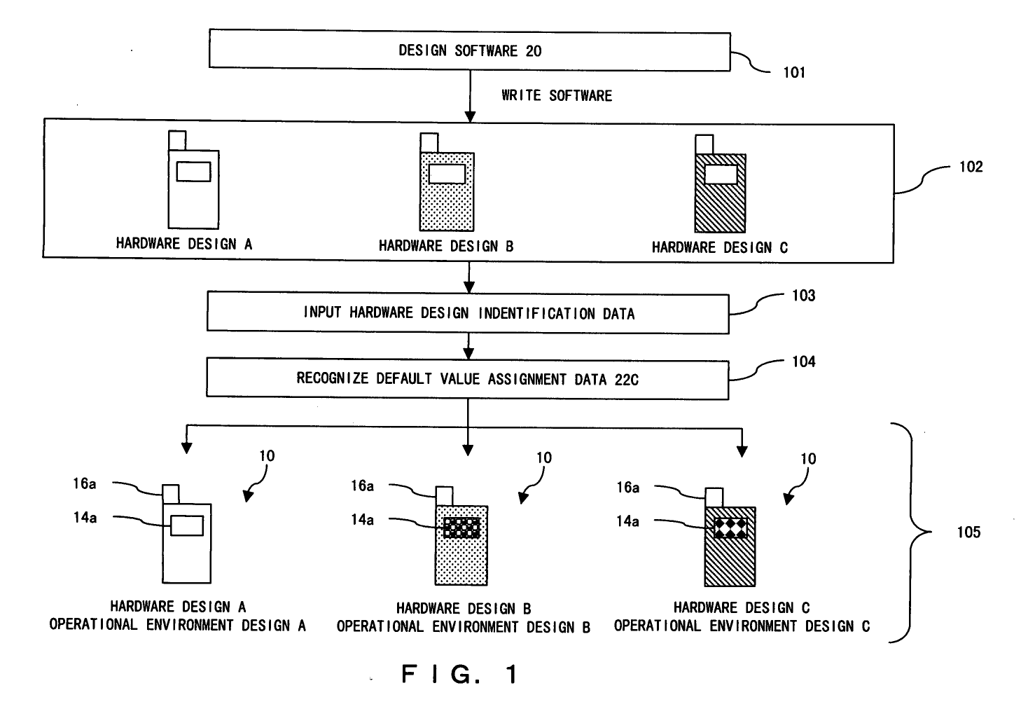

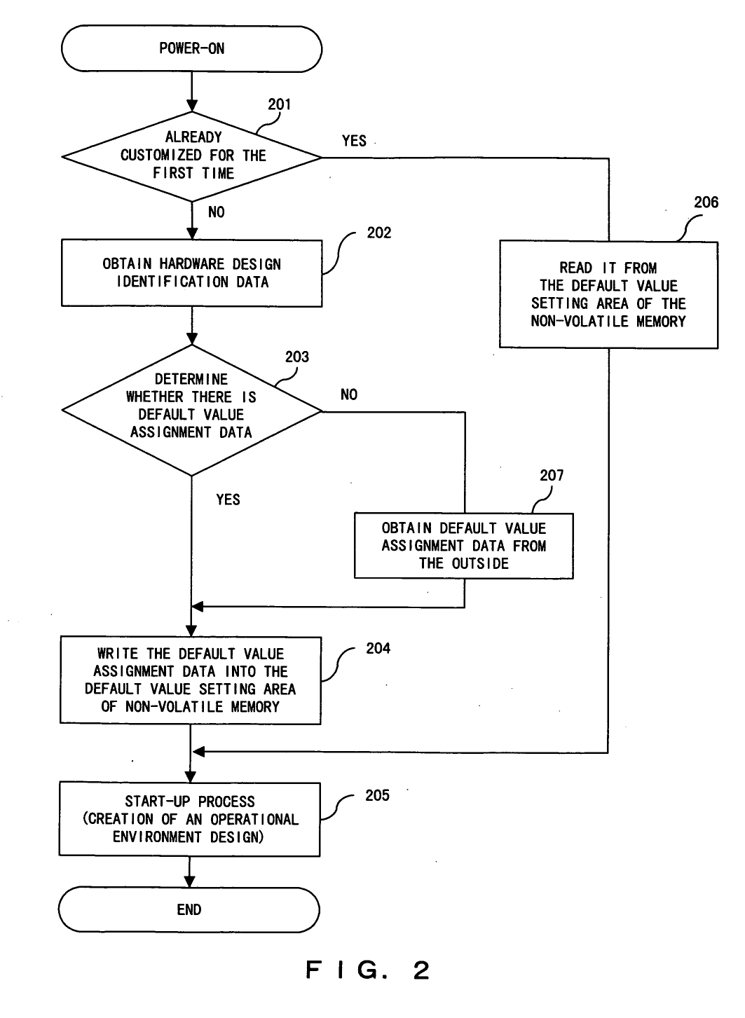

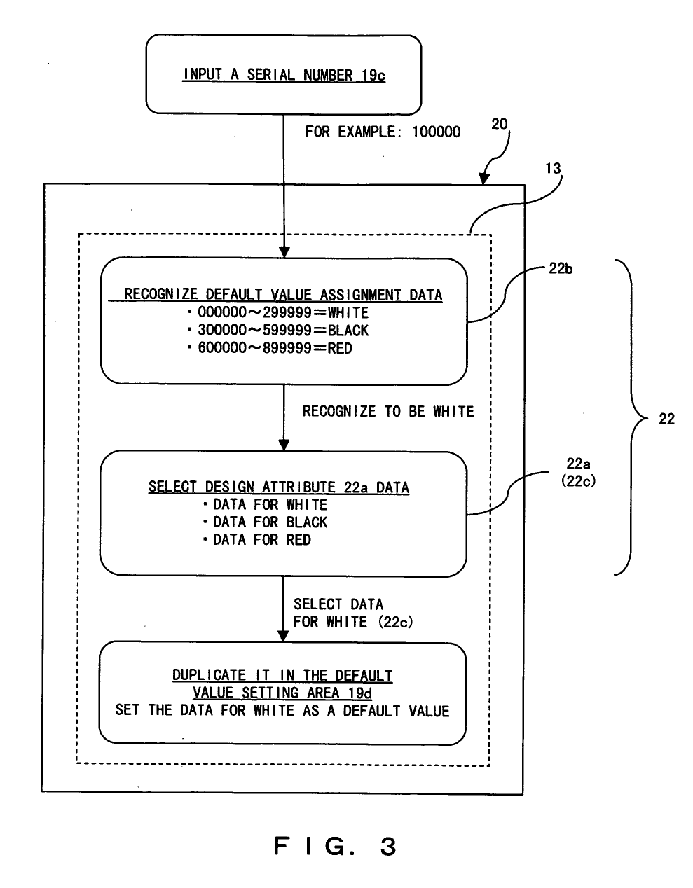

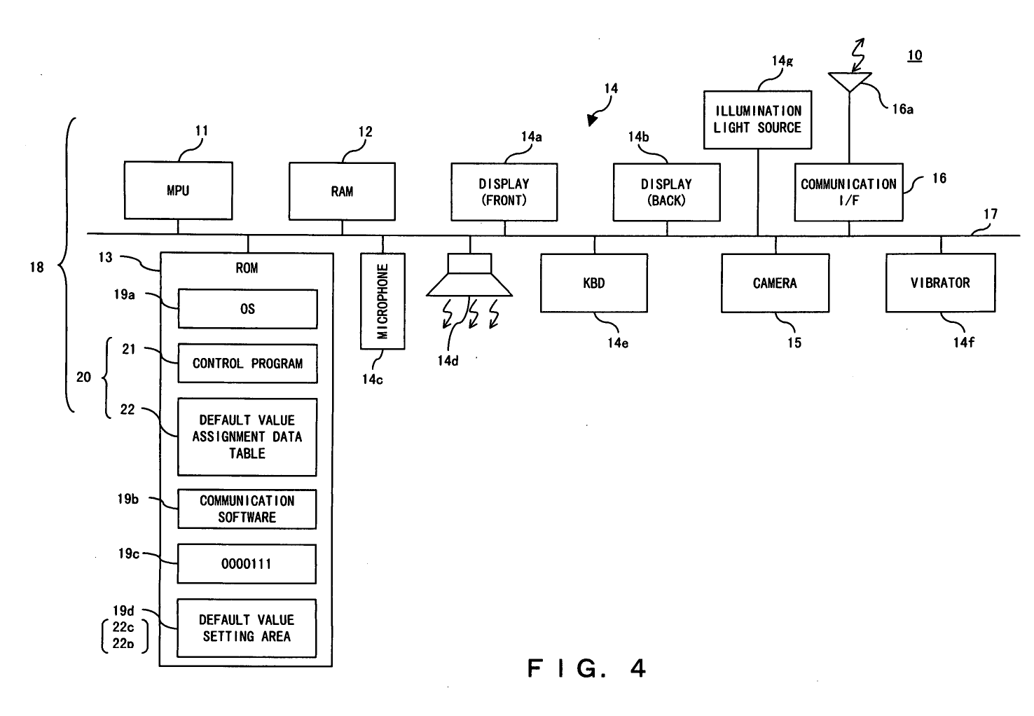

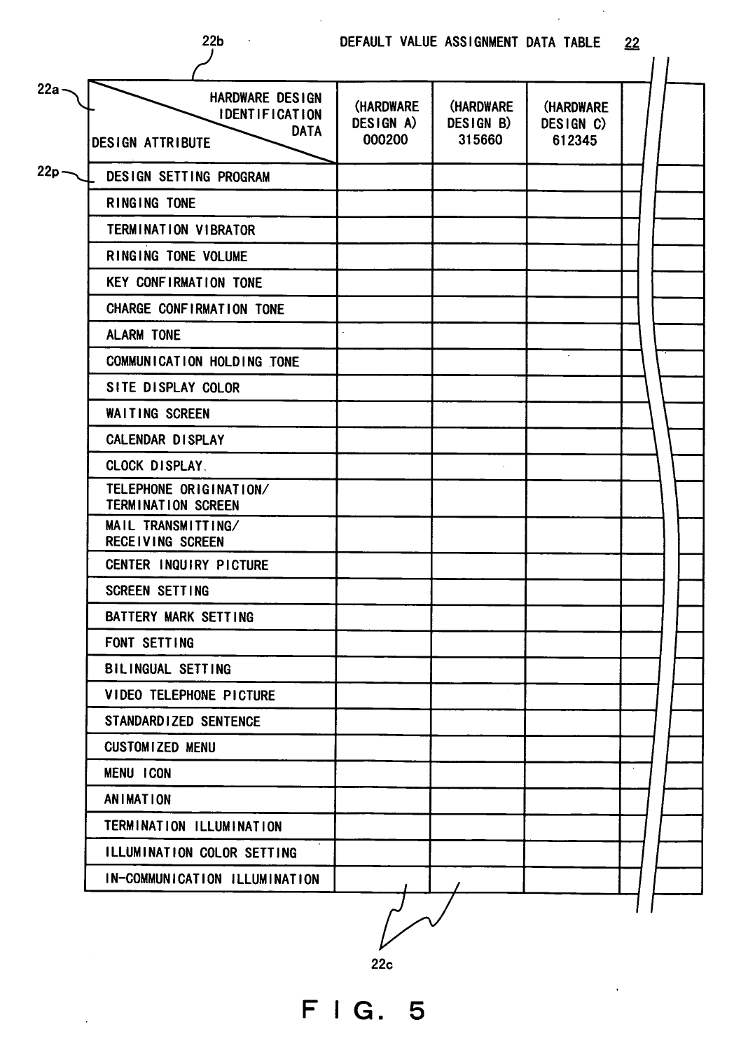

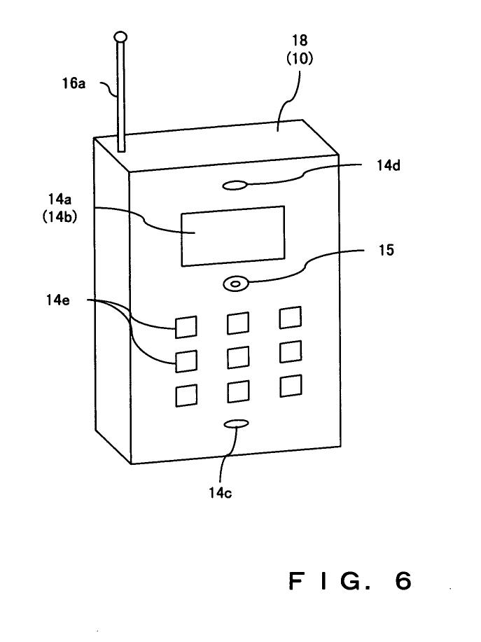

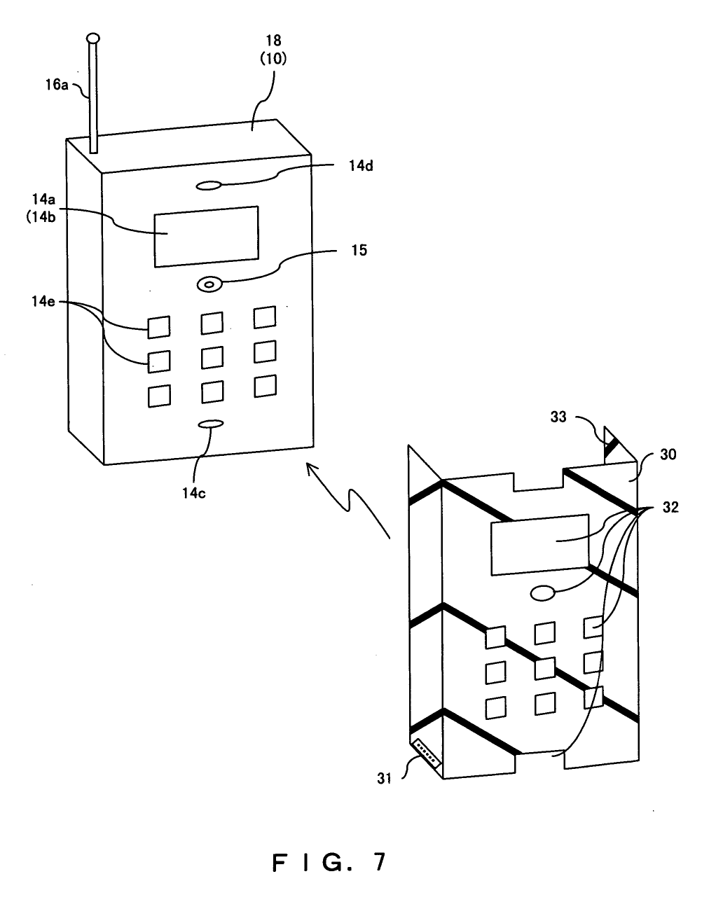

FIG. 1 is a flowchart showing an example of the manufacturing process of the data processing device in the first aspect of the present invention. FIG. 2 is a flowchart showing an example of the operation of the data processing device in the first aspect of the present invention. FIG. 3 shows the basic flow showing an example of the operation of the data processing device in the first aspect of the present invention. FIG. 4 is a block diagram showing an example of the configuration of the data processing device in the first aspect of the present invention. FIG. 5 shows data possessed by the data processing device in the first aspect of the present invention. FIG. 6 is a perspective illustration showing an example of the appearance of the data processing device in the first aspect of the present invention. FIG. 7 is a perspective illustration showing a variation of the data processing device in the first aspect of the present invention.

Firstly, an example of the configuration of the data processing device of the preferred embodiment with reference to FIGS. 4 and 6. Although in this preferred embodiment, a portable terminal, such as a cellular phone, a personal digital assistant (PDA) or the like, is described as one example of the data processing device, the data processing device is not limited to them, and the present invention is widely applicable to a general data processing device provided with a user interface.

The data processing device 10 of this preferred embodiment comprises a micro processor unit (MPU) 11, main memory 12, a non-volatile storage device 13, a user interface 14, a camera 15 and a communication interface 16 and a bus 17 as a data transmission line, which are all housed in a cabinet 18.

The MPU 11 controls the entire data processing device 10 by executing a program stored in the main memory 12.

The main memory 12 is composed of storage media, such as random-access memory (RAM) or the like, and stores a program and data that are executed by the MPU 11.

The non-volatile storage device 13 is composed of storage media, such as re-writable read-only memory (ROM) or the like, and stores basic software 19a, communication control software (control unit) 19b and a serial number 19c. Data stored in this non-volatile storage device 13 is loaded onto the main memory 12 and is accessed or executed by the MPU 11, as requested.

The non-volatile storage device 13 is also provided with a default value setting area 19d. In this default value setting area 19d, a group of the default value assignment data (design setting data) 22c of a design attribute 22a, which is described later, is stored in order to realize a specific operational environment design in the user interface 14.

The basic software 19a is made of a commercial operation system. The communication control software 19b operates based on this basic software 19a, and controls the operation of the entire data processing device when being executed by the MPU 11.

The serial number 19c is identification data uniquely attached to each data processing device. The serial number 19c is attached to discriminate a plurality of different hardware designs, such as the appearance of the data processing device and the like.

For example, a serial number 19c is assigned to each color of the cabinet 18, and when the serial number 19c is recognized, the color of the cabinet 18 can be identified.

If the serial number 19c is “123450000506789”, six underlined digits indicate the number of sets.

In this case, for example, if 900,000 data processing devices 10 housed in the cabinets 18 of three colors of white, black and red, numbers 000000˜299999, 300000˜599999 and 600000˜899999 are assigned to white, black and red, respectively.

Thus, the design, such as color, shape, pattern and the like, of the cabinet 18 can be discriminated by a partial digit value of the serial number 19c.

The user interface 14 comprises a first display 14a, a second display 14b, a microphone 14c, a speaker 14d, a keyboard 14e, a vibrator 14f, an illumination light source 14g and the like.

The first display 14a and the second display 14b are disposed, for example, on the front and back sides, respectively, of the cabinet 18 visibly display data.

The microphone 14c inputs voice and the like. The speaker 14d outputs voice. If the data processing device 10 is used as a cellular phone, the microphone 14c and the speaker 14d function as a transmitter and a receiver, respectively. A video telephone can also be realized by using the first display 14a and camera 15 together with the microphone 14c and speaker 14d.

The keyboard 14e inputs character data and a command. The vibrator 14f is composed of a motor for vibrating the cabinet 18 and the like, and warns a user by vibrating the cabinet 18.

The illumination light source 14g comprises a function to illuminate the inside of the first display 14a or the second display 14b, or the cabinet 18, with a variety of colors.

The camera 15 comprises a function to take a picture and to input it as picture data.

The communication interface 16 comprises, for example, an antenna 16a, and comprises a function to wirelessly transmit/receive data to/from the outside. Specifically, if the data processing device 10 is a cellular phone, the communication interface 16 wirelessly communicates with the outside. Alternatively, if the data processing device is connected to a wide-area network, such as the Internet or the like, via the communication interface 16, it can transmit/receive data via the Internet.

In this preferred embodiment, the non-volatile storage device 13 further comprises design software 20 composed of a design control program 21 (identification data acquisition unit) and a default value assignment data table 22 (setting data storage unit) 22.

This design software 20 sets the appearance hardware design of the cabinet 18 of the data processing device 10, that is, the default status of an operational environment design concerning the user interface 14 or the like.

Specifically, as exemplified in FIG. 5, the default value assignment data table 22 stores the default value assignment data 22c of each field of the design attribute 22a (display data, sound data, vibration data and a program), which is the factor of an operational environment design, for each piece of hardware design identification data 22b.

Then, the design control program 21, for example, recognizes a serial number 19c stored in the non-volatile storage device 13, selects and reads a set of the default value assignment data 22c of the design attribute 22a corresponding to the serial number 19c from the default value assignment data table 22 and sets the data in the default value setting area 19d.

Then, if a design setting program 22p (control unit) included in the design attribute 22a, a design control program 21 and communication control software 19b and the like accesses the default value assignment data 22c of the design attribute 22a stored in this default value setting area 19d and controls the user interface 14, an operational environment design matched with the appearance design taste of the data processing device 10 specified by the serial number 19c can be realized.

For example, in the example of the default value assignment data table 22, the following fields are set as the design attribute 22a.

Specifically, a set of the following pieces of default value assignment data 22c of the design attribute 22a of a specific serial number 19c are selected.

In other words, the design attribute 22a includes the design setting program 22p. This design setting program 22p creates an operational environment design, according to default value assignment data 22c corresponding to the following design attribute 22a set in the default value setting area 19d.

The design attribute 22a also comprises, for example, the following fields as data for controlling the speaker 14d and vibrator 14f.

Specifically, “ringing tone” defines music, voice or the like at the time of termination in a mail, a message, voice, a video telephone and the like.

“Termination vibrator” defines the vibration generated by the vibrator 14f at the time of termination in a mail, a message, voice, a video telephone and the like.

“Ringing tone volume” defines the ringing sound volume at the time of termination in mail, message, voice, video telephone and the like.

“Key confirmation tone” defines tone generated when the key on the keyboard 14e is pushed.

“Charge confirmation tone” defines voice outputted to notify a user of charge completion.

“Alarm tone” defines voice outputted in order to warn a user when an error occurs or the like.

“Communication holding tone” defines holding tone at the time of communication by telephone and video telephone.

The design attribute 22a also comprises the following pieces of field data as data for controlling the first display 14a, second display 14b and illumination light source 14g.

Specifically, “site display color” defines the color of light outputted from the first display 14a, second display 14b and illumination light source 14g in order to discriminate an access destination when accessing to the Internet.

“Waiting screen” defines the design of a screen displayed on a main display (the first display 14a), back display (the second display 14b) and the like while the data processing device 10 is waiting.

“Calendar display” defines the design of a calendar outputted on the main and back displays.

“Clock display” defines the design of a clock outputted on the main and back displays.

“Telephone origination/termination screen” defines the design of an image outputted on the main and back displays at the time of origination/termination when the data processing device is used as a telephone set.

“Mail transmitting/receiving screen” defines the design of an image outputted on the main and back displays when transmitting/receiving a mail.

“Center inquiry picture” defines the design of an image outputted on the main and back displays when the user of the data processing device 10 accesses the support site.

“Screen setting” defines a background image outputted on the main and back displays.

“Battery mark setting” defines a design for displaying the remaining amount of a battery on the main and back displays.

“Font setting” defines the font of a character outputted on the first display 14a and second display 14b.

“Bilingual setting” defines the design of an output image on the first display 14a and second display 14b when multiple languages are available.

“Video telephone picture” defines the design of an output image on the first display 14a and second display 14b when using the data processing device 10 as a video telephone set.

“Standardized sentence” defines the style of a fixed sentence and the design of an image that are used when transmitting a mail.

“Customized menu” defines the design of a menu screen and the like outputted on the first display 14a and second display 14b when a user customizes each function of the data processing device 10.

“Menu icon” defines the design of a variety of menu screens outputted on the first display 14a and second display 14b.

“Animation” defines the design of a variety of animation outputted on the first display 14a and second display 14b.

“Terminating illumination” defines the design of illumination realized on the first display 14a, second display 14b and illumination light source 14g at the time of termination in mail, message, voice, video telephone and the like.

“Illumination color setting” defines the illumination color of the illumination light source 14g.

“In-communication illumination” defines the design of the illumination of the first display 14a, second display 14b and illumination light source 14g during communication.

In addition to the above-mentioned fields exemplified in FIG. 5, the following fields are also considered as the design attribute 22a.

“Receiving tone volume setting” adjusts the tone volume of the voice of the partner in communication.

“Battery alarm tone setting” sets the alarm tone in the case where the battery has run down.

“Manner-mode setting” sets a manner mode type (as predetermined or originally).

“Termination call operation setting” sets a time period until a ringing tone starts after receiving a call.

“No originating number operation setting” sets an operation in the case where the partner does not notify an originator number when there is a call.

“Earphone switch setting” sets a ringing tone from an earphone to a speaker in the case where an earphone/microphone set is used.

“Auto termination function setting” sets whether to automatically answer when external equipment, such as an earphone/microphone or the like is used.

“Any key answer setting” sets whether a call can be answered by pushing any key where there is the call.

“Priority communication mode setting” sets which screen is displayed with priority when there is packet communication during audio communication or when there is audio communication during packet communication.

“Noise canceller setting” sets whether to suppress ambient noise during communication.

“Reconnection alarm setting” sets whether to reconnect a telephone line disconnected during communication due to a poor radio wave condition.

“Communication quality alarm tone setting” sets whether to issue an alarm when there is a possibility that communication may be interrupted during communication due to a poor communication condition.

“Automatic overseas dial addition setting” sets whether to automatically add a number for an overseas connection and to originate a call.

“During-communication closing setting” sets an operation in the case where a cellular phone is closed during communication.

“Video telephone operation setting” sets in detail a screen during video communication and the like.

“Character input setting” sets a method and an operation at the time of character input.

“Mail-attached file setting” sets whether to receive an attached file when receiving a mail.

“Mail list display setting” sets the layout when displaying a mail list.

“Automatic mail-attached file reproduction setting” sets whether to reproduce a melody or the like when it is attached to a received mail.

“Mail receiving display setting” sets whether to notify when receiving a mail during some operation.

“Site-connection waiting time setting” sets the maximum waiting time at the time of connection to a site on the Internet.

“Site display/effect setting” sets display and a sound operation in the case where a sire on the Internet is displayed.

“i motion setting” sets whether to automatically reproduce i motion (trademark).

“Automatic i application start setting” sets whether to automatically start an i application (trademark) (Internet access application program) where there is an automatically activable i application.

“Software data display setting” sets whether to display data about software when downloading software.

“Software illumination setting” sets illumination during a software operation.

“Message memo setting” sets the response time and guidance of a message memo, and a variety of functions.

“Camera setting” sets in detail effect, brightness, color density and the like when the camera 15 is used.

Then, the design setting program 22p included in the selected design attribute 22a creates a operational environment design by controlling the output of an image or the like to the first display 14a and second display 14b, outputting voice to the speaker 14d, controlling the light emission of the illumination light source 14g, controlling the vibration of the vibrator 14f and the like.

One example of the operation of this preferred embodiment is described below. As exemplified in the flowchart shown In FIG. 1, firstly, the design software 20 composed of the design control program 21 and default value assignment data table 22 is prepared (step 101).

Then, in the manufacturing process of the data processing device 10, after the completion of the hardware manufacturing of the data processing device 10, the design software is installed in the non-volatile storage device 13 (step 102). Thus, in the data processing device 10, a plurality of hardware designs A, B, C and so on becomes available as the default value assignment data table 22.

Then, when the data processing device 10 is started, the design control program 21 is operated and the serial number 19 with the hardware designs, such as the appearance and the like, of the data processing device 10 discriminably attached is inputted to the design control program 21 (step 103), the hardware design identification data 22b of the default value assignment data table 22 is searched for using this serial number 19c. Then, a set of corresponding design attribute 22a is selected and written into the default value setting area 19d (step 104).

Thus, an operational environment design composed of the combination of visual, auditory and tactile (such as vibrational, etc.) attributes matched with the appearance design taste of the data processing device 10 can be realized (step 105).

Specifically, for example, if the appearance color of the data processing device 10 is brightly red, the appearance design taste of the data processing device 10 can be matched with an operational environment design taste by unifying an image, icon and the like displayed on the first display 14a and the like in a red family and also unifying a variety of sounds by a melody giving an active influence, in accordance with it.

The flowchart shown in FIG. 2 shows the detailed operation of the design control program 21 in steps 103 and 104 shown in FIG. 1.

When the power of the data processing device 10 is switched on, the design control program 21 determines whether the default value of the operational environment design is already set in the default value setting area 19d (step 201). If the default value is not set yet, the hardware design identification data (such as the serial number 19c) of the data processing device 10 is obtained (step 202), and the hardware design identification data 22b of the default value assignment data table 22 is retrieved using the hardware design identification data (step 203).

If there is a matched default value in the default value assignment data table 22, a set of corresponding design attributes 22a is read and are written into the default value setting area 19d (step 204).

FIG. 3 shows one example of this retrieval process in the default value assignment data table 22.

Then, an operational environment matched with the hardware design taste of the data processing device 10 using the data of the design attributes 22a set in the default value setting area 19d (that is, a default operational environment design matched with the hardware design taste of the data processing device 10 is realized)(step 205).

However, if in step 201 it is found that the default value of the operational environment design is already set in the default value setting area 19d, immediately the set value of the design attribute 22a (default value assignment data 22c) from the default value setting area 19d is read (step 206) and in step 205 an operational environment is created.

If in step 203 there is no hardware design identification data 22b corresponding to the hardware design identification data in the default value assignment data table 22, the default value assignment data 22c is inputted from the outside (step 207), and the processes in steps 204 and after are performed.

The default value data of the design attribute 22a set in the default value setting area 19d is stored without any modifications even if a user resets the setting.

For the acquisition method of the hardware design identification data in step 202, any method, such as a method for reading the serial number 19c written in the non-volatile storage device when manufacturing the data processing device 10, a method for reading the serial number 19c by a bar code or the like from an external medium by means of image recognition using the camera 15, a method for automatically recognizing the hardware design name of the data processing device 10 by image recognition using the camera 15, a method for recognizing the appearance design itself of the data processing device 10 by recognizing the appearance image reflected on a mirror, of the data processing device 10 or the like can be used.

As described above, according to the data processing device 10 of this preferred embodiment, the design software 20 composed of the design control program 21 and default value assignment data table 22 can be installed, the hardware design of the cabinet 18 can be identified by the design control program 21, the default value assignment data 22c about the design attribute 22a is selected from the default value assignment data table 22 in such a way that the operational environment design of the user interface 14, matched with this hardware design taste can be created and the default value assignment data 22c can be automatically set in the default value setting area 19d as a default value.

As a result, the appropriate operational environment design of the user interface 14, matched with the cabinet design taste of the data processing device 10 can be realized without bothering the user of the data processing device 10.

In the manufacturing process of the data processing device 10, there is no need to individually prepare software and data for each different hardware design taste of the cabinet 18, and a data processing device provided with an appropriate operational environment design matched with the design taste, such as color, shape, pattern and the like of the cabinet 18 of the data processing device 10 can be provided without the increase of development man-hours, troublesome software management and the like.

Since the default value assignment data 22c of the design attribute 22a, stored in the default value setting area 19d does not change, the operational environment design matched with the design taste of the cabinet 18 can be maintained even when a user restores the operational environment design after customizing it.

Next, an example of the variation of the data processing device 10 of this preferred embodiment is described with reference to FIG. 7.

In the variation example shown in FIG. 7, if the hardware design of the cabinet 18 is modified by the so-called “dress-up” by a user after shipment, of the data processing device 10, the default operational environment design corresponding to this hardware design taste can be automatically set.

Specifically, as to a dress-up sheet 30, its front side has a striped design and its back side is an adhesion portion 33 coated with an adhesive or the like. The area of the dress-up sheet 30, corresponding to the speaker 14d, first display 14a, second display 14b, keyboard 14e and microphone 14c is provided with a cutout part 32.

Thus, the appearance design can be modified without the loss of the function of the user interface 14 of the data processing device 10 by pasting the dress-up sheet 30 on the cabinet 18.

On a part of the dress-up sheet 30, design identification data 31 for identifying the design of the dress-up sheet 30 is printed. For this design identification data, any expression method, such as a character, a bar code, a two-dimensional code, an image or the like can be used.

In the case of this variation, a default operational environment design matched with the design taste of the dress-up sheet 30 can be automatically created by taking the picture of the design identification data 31 using the camera 15, identifying the design type of the dress-up sheet 30, retrieving and reading the default value assignment data 22c of a corresponding design attribute 22a and setting it in the default value setting area 19d.

If there is no data corresponding to the design identification data 31 in the default value assignment data table 22, an external data server or the like on the Internet can also be accessed via the communication interface 16, and the default value assignment data 22c of the design attribute 22a can also be obtained.

For example, the design identification data 31 itself can also be a uniform resource locator (URL) for specifying the location of a data source in the Internet. Specifically, by using the design identification data 31 as a URL for specifying the data server on a site run by the provider of the dress-up sheet 30, a default operational environment design also precisely corresponding to the future design modification of the cabinet by pasting the dress-up sheet 30 can be created.

Specifically, the user of the data processing device 10 can realize an operational environment design with an appropriate taste corresponding to the design change of the cabinet 18 by pasting the dress-up sheet 30 after shipment , of the data processing device, without a troublesome setting operation.

The present invention is not limited to the configurations exemplified in the above-mentioned preferred embodiments, and a variety of its variations and modifications are also possible as long as the subject matter is not deviated.

For example, the shape of the cabinet 18 of the data processing device 10 is not limited to one exemplified in FIG. 6, and any shape, such as a folded type or the like can be used.

According to the present invention, an appropriate operational environment design matched with the design taste of the cabinet design of a data processing device can be easily and rapidly can be realized without bothering a user.

A data processing device provided with an appropriate operational environment design matched with the design taste of the cabinet design can be provided without the increase of development man-hours and troublesome software management.

A data processing device capable of realizing an appropriate operational environment design corresponding to the change of a cabinet design after shipment can be provided without a troublesome setting operation.

What is claimed is:

1. A data processing device provided with a user interface, comprising:
a setting data storage unit which stores design setting data in order to realize a plurality of operational environment designs corresponding to each different appearance design of the data processing device;
an identification data acquisition unit which obtains identification data uniquely set for each of the appearance designs of the data processing device; and
a control unit which reads the design setting data corresponding to the appearance design of the data processing device specified by the identification data and setting the operational environment design in the data processing device.

2. The data processing device according to claim 1, wherein
said user interface comprises at least one of an data display unit, an audio input/output unit and a vibration generation unit, and
the operational environment design comprises at least one of an image an icon, illumination, music, voice and vibration which are outputted by at least one of the data display unit, an audio input/output unit and a vibration generation unit, in connection with the operation of said data processing device.

3. The data processing device according to claim 1, wherein
the appearance design is composed of at least one of the shape, color and pattern of a cabinet of said data processing device.

4. The data processing device according to claim 1, wherein
the appearance design is composed of at least one of the shape, color and pattern of a covering material attached to cover at least a part of said data processing device.

5. The data processing device according to claim 1, wherein
said identification data acquisition unit identifies the appearance design by reading the identification data of the relevant data processing device, stored in said data processing device.

6. The data processing device according to claim 1, wherein
said user interface further comprises a camera unit, and
said camera unit functions as the identification data acquisition unit, and identifies the appearance design by either a method which takes a picture of the appearance of said data processing device using said camera unit or a method which takes a picture of identification data about said data processing device using said camera unit.

7. A control method of a data processing device, comprising:
a first step of setting design software in the data processing device in order to realize a plurality of operational environment designs corresponding each different appearance design of the data processing device;
a second step of identifying the appearance design of the data processing device, according to hardware design identification data; and
a third step of setting the operational environment design in the data processing device, using the design software corresponding to the identification result of the second step.

8. The control method of a data processing device according to claim 7, wherein
said data processing device comprises at least one of an data display unit, an audio input/output unit and a vibration generation unit, and
the operational environment design comprises at least one of an image, an icon, illumination, music, voice and vibration which are outputted by at least one of the data display unit, the audio input/output unit and the vibration generation unit, in connection with the operation of said data processing device.

9. The control method of a data processing device according to claim 7, wherein
the appearance design is composed of at least one of the shape, color and pattern of a cabinet of said data processing device.

10. The control method of a data processing device according to claim 7, wherein
the appearance design is composed of at least one of the shape, color and pattern of a covering material attached to cover at least a part of said data processing device.

11. The control method of a data processing device according to claim 7, wherein
said data processing device further comprises
a camera unit, and
said second step comprises one of a method which identifies the appearance design by reading identification data about the relevant data processing device, stored in said data processing device, a method which identifies the appearance design by taking a picture of the appearance of said data processing device using the camera unit and a method which identifies the appearance design by taking a picture of identification data of said data processing device using the camera unit.

12. A signal carrying a control program which enables a data processing device provided with a user interface to execute a process, said process comprising:
a first step of identifying the appearance design of the data processing device, according to hardware design identification data;
a second step of selecting design software corresponding to an identification result of the first step from a plurality of pieces of design software in order to realize a plurality of operational environment designs corresponding to each different appearance design of the data processing device; and
a third step of setting the operational environment design in the data processing process, using the selected design software.

13. The signal carrying a control program according to claim 12, wherein
said user interface comprises at least one of an data display unit, an audio input/output unit and a vibration generation unit, and
the operational environment design comprises at least one of an image, an icon, illumination, music, voice and vibration which are outputted by at least one of the data display unit, the audio input/output unit and the vibration generation unit, in connection with the operation of said data processing device.

14. The signal carrying a control program according to claim 12, wherein
the appearance design is composed of at least one of the shape, color and pattern of a cabinet of said data processing device.

15. The signal carrying a control program according to claim 12, wherein
the appearance design is composed of at least one of the shape, color and pattern of a covering material attached to cover at least a part of said data processing device.

16. The signal carrying a control program according to claim 12, wherein
said first step identifies the appearance design by reading identification data of the relevant data processing device stored in said data processing device.

17. The signal carrying a control program according to claim 12, wherein
said user interface further comprises
a camera unit, and
said second step comprises one of a method which identifies the appearance design by reading identification data about the relevant data processing device, stored in said data processing device, a method which identifies the appearance design by taking a picture of the appearance of said data processing device using the camera unit and a method which identifies the appearance design by taking a picture of identification data of said data processing device using the camera unit.
